(19) United States
(12) Patent Application Publication
(10) Pub. No.: US 2005/0036046 A1
(43) Pub. Date: Feb. 17, 2005

(54) Method of or device for processing image data, a processed image data format, and a method of or device for displaying at least one image from the processed image data

(75) Inventor: Eiji Atsum, Kanagawa (JP)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/640,897

(22) Filed: Aug. 14, 2003

(51) Int. Cl. H04N 5/247

(52) U.S. Cl. 348/264

(57) ABSTRACT

A method of processing first image data representative of a first image and second image data representative of a substantially contemporaneous second image is described. The method comprises: processing stripes of the first image data sequentially; processing stripes of the second image data sequentially; outputting a first sequence of first data units interleaved with a second sequence of second data units, wherein each of the first data units represents a processed stripe of first image data and each of the second data units represents a processed stripe of second image data.

### FIELD OF THE INVENTION

Embodiments of the invention relate to a method of or device for processing first image data representative of a first image and second image data representative of a substantially contemporaneous second image, a processed image data format comprising a first sequence of first data units associated with the first image interleaved with a second sequence of second data units associated with the second image, and a method of or device for displaying at least one image from the processed data.

### BACKGROUND TO THE INVENTION

Twin-cameras have been provided on some recent mobile telephones. The image data from each of the twin cameras is separately reconstructed and compressed on a frame by frame basis.

In one implementation, each of the twin cameras has a lens, a sensor and a processor. Each processor separately uses a full frame memory to produce a compressed image file. This implementation uses a large number of components, has a high cost, and it is difficult to manage the two consequent compressed image files.

In another implementation, such as in JP2002-77942A, a single extra large sensor is used with two lenses. One lens focuses on a first part of the sensor and the other lens focuses on a second part of the sensor. An extra large frame memory is required and the side-by-side images are simultaneously compressed.

Examples of current twin camera mobile telephones by DoCoMo include F5041S, N5041S and P5041S.

### BRIEF SUMMARY OF THE INVENTION

According to one embodiment of the invention there is provided a method of processing first image data representative of a first image and second image data representative of a substantially contemporaneous second image, comprising: processing stripes of the first image data sequentially; processing stripes of the second image data sequentially; outputting a first sequence of first data units interleaved with a second sequence of second data units, wherein each of the first data units represents a processed stripe of first image data and each of the second data units represents a processed stripe of second image data.

According to another embodiment of the invention there is provided a device for processing first image data representative of a first image and second image data representative of a substantially contemporaneous second image, the device comprising a first input for receiving first image data, a second input for receiving second image data and an output, wherein the device is arranged to process stripes of the first image data sequentially and process stripes of the second image data sequentially and output a first sequence of first data units interleaved with a second sequence of second data units, wherein each of the first data units represents a processed stripe of first image data and each of the second data units represents a processed stripe of second image data.

Two separate outputs of image data, the first image data and the second image data, are converted to a single output comprising a first sequence of first data units interleaved with a second sequence of second data units. The single output may, for example, be used to create a single data file and/or may be used to interface to the base band of current mobile telephone architectures. Embodiments of the invention can use a single processor to provide the single output. This provides size and cost savings.

According to a further embodiment of the invention there is provided a data format for image data, comprising a first sequence of first data units interleaved with a second sequence of second data units, wherein each of the first data units represents a stripe of first image data and each of the second data units represents a stripe of second image data.

According to another embodiment of the invention there is provided a method of displaying at least one image from a first sequence of first data units interleaved with a second sequence of second data units, comprising: parsing input data comprising first data units and the second data units wherein each of the first data units represents a stripe of first image data and each of the second data units represents a stripe of second image data; and using the parsed first data units and/or second data units to reproduce the first image and/or the second image.

According to a further embodiment of the invention there is provided a device for displaying at least one image derived from a first sequence of first data units interleaved with a second sequence of second data units, comprising: parsing means for parsing input data comprising first data units and the second data units wherein each of the first data units represents a stripe of first image data and each of the second data units represents a stripe of second image data; and reproduction means for reproducing the first image and/or the second image using the parsed first data units and/or parsed second data units.

### BRIEF DESCRIPTION OF DRAWINGS

For a better understanding of the present invention and to understand how the same may be brought into effect, reference will now be made by way of example only to the accompanying drawings in which:

FIG. 1 illustrates a dual camera system;

FIG. 2A illustrates the output of data from the sensor of a first camera module;

FIG. 2A illustrates the output of data from the sensor of a second camera module;

FIG. 2C illustrates processed data output by the processor on the fly;

FIG. 2D illustrates compressed data output by the encoder on the fly;

FIG. 3 schematically illustrates the encoder;

FIG. 4 schematically illustrates the decoder; and

FIGS. 5A, 5B and 5C illustrate different possible inputs to the image/video viewer.

### DETAILED DESCRIPTION OF EMBODIMENT(S) OF THE INVENTION

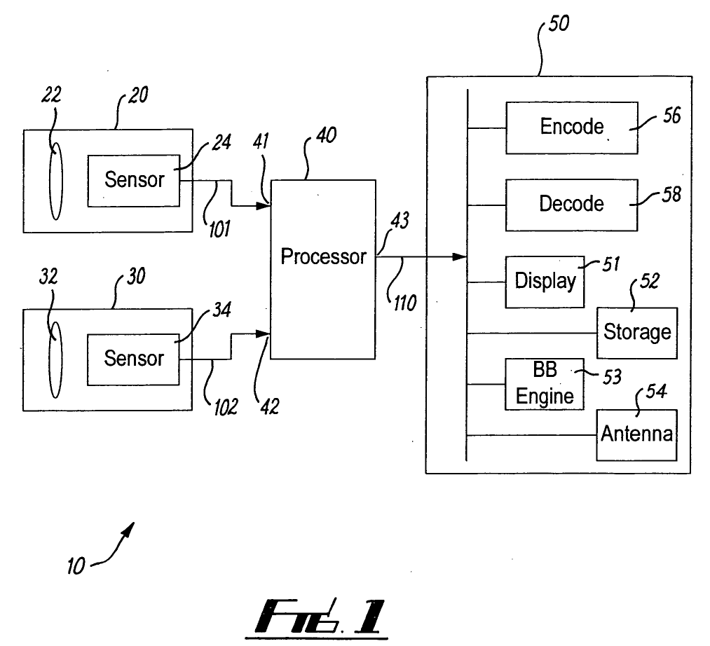

FIG. 1 illustrates a dual camera system 10. The dual camera system 10 comprises:
a first camera module 20; a second camera module 30; a processor 40; and a host device 50, such as a mobile telephone.

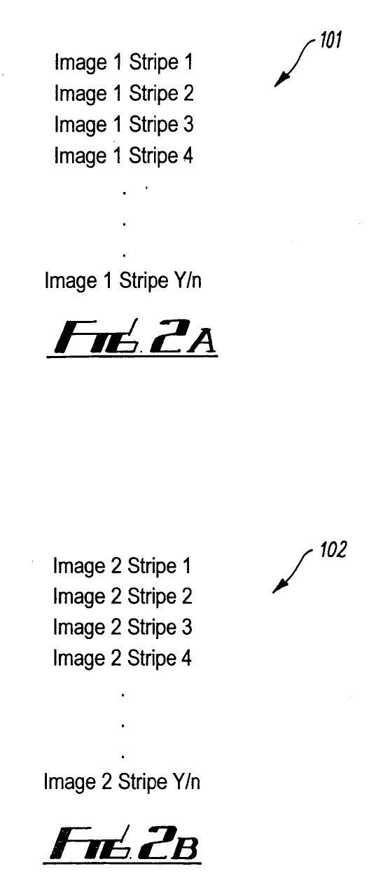

The first camera module 20 comprises a lens 22 and a sensor 24, for example, an X column by Y row array of charge coupled devices. The first camera module 20 captures a first image, for example, as X*Y pixels of first image data. The first image data may therefore be represented as Y rows of X pixels. The first image data can be logically divided into separate similarly sized portions where each portion includes Y/n non-overlapping stripes, where each stripe is a group of n consecutive rows of X pixels. FIG. 2A illustrates the output data 101 from the sensor 24 of the first camera module 20. There are Y/n stripes, each of which is formed from n rows of X pixels.

The second camera module 30 comprises a lens 32 and a sensor 34, for example, an X column by Y row array of charge coupled devices. The second camera module 30 captures a second image, for example, as X*Y pixels of second image data. The second image data may therefore be represented as Y rows of X pixels. The second image data can be logically divided into separate similarly sized portions where each portion includes Y/n non-overlapping stripes, where each stripe is a group of n consecutive rows of X pixels. FIG. 2B illustrates the output data 102 from the sensor 44 of the second camera module 30. There are Y/n stripes each of which is formed from n rows of X pixels.

The processor 40 has a first input interface 41, a second input interface 42 and an output interface 43. The first input interface 41 is connected, in this example, to the output of the sensor 24 of the first camera module 20. The second input interface 42 is connected, in this example, to the output of the sensor 34 of the second camera module 30. The output interface 43 is connected to the base band of the host device 50.

The processor 40 processes separately and sequentially the stripes of the first image data and processes separately and sequentially the stripes of the second image data. It produces processed data 110 made up from a first sequence of first data units 112 interleaved with a second sequence of second data units 114 as illustrated in FIG. 2C. Each of the first sequence of first data units 112 represents a processed stripe of the first image data. Each of the second sequence of second data units 114 represents a processed stripe of second image data. The processing occurs ‘on-the-fly’ without storing data representative of the whole of the first image or data representative of the whole of the second image.

In more detail, in the example illustrated, the processor 40 simultaneously processes a first stripe of the first image data (Image 1 Stripe 1) and a first stripe of a second image data (Image 2 Stripe 1) as if it where a 2X*n image and then outputs at its output interface 43 the first data unit in the first sequence (Processed Image 1 Stripe 1) and then the first data unit in the second sequence (Processed Image 2 Stripe 1). The processor 40 then simultaneously processes a second stripe of the first image data (Image 1 Stripe 2) and a second stripe of a second image data (Image 2 Stripe 2) as if it where a 2X*n image and then outputs at its output interface 43 the second data unit in the first sequence (Processed Image 1 Stripe 2) and then the second data unit in the second sequence (Processed Image 2 Stripe 2). In this way the processor 40 processes separately and sequentially the stripes of the first image data and processes separately and sequentially the stripes of the second image data and produces an output 110 in which the processed stripes of the first image data 112 are interleaved with the processed stripes 114 of the second image data. The processing is on raw pixel data and includes image reconstruction from the data received from first and second image sensors. The image reconstruction is performed by image pipeline processing that may involve pre-processing, CFA interpolation and post interpolation.

In other embodiments, where the camera modules include image processors, the data received at the first and second input interfaces is not raw, but pre-processed and the processor 40 provides a data formatting function. The processor 40 interleaves the processed first image stripes received from the first camera module 20 with processed second mage stripes received from the second camera module 30.

The host device 50 is in this example a mobile telephone, although other host devices may be used such personal computers, personal digital assistants etc.

The host device 50 comprises a display 51, a memory 52 for storage, a base-band engine 53 of the mobile telephone and an antenna 54. The host device 50 additionally provides an encode (compression) function which may be provided by encoding circuitry 56 or a suitably programmed processor within the base band engine 53. The host device additionally provides a decode (decompression) function which may be provided by decoding circuitry 58 or a suitably programmed processor within the base band engine 53.

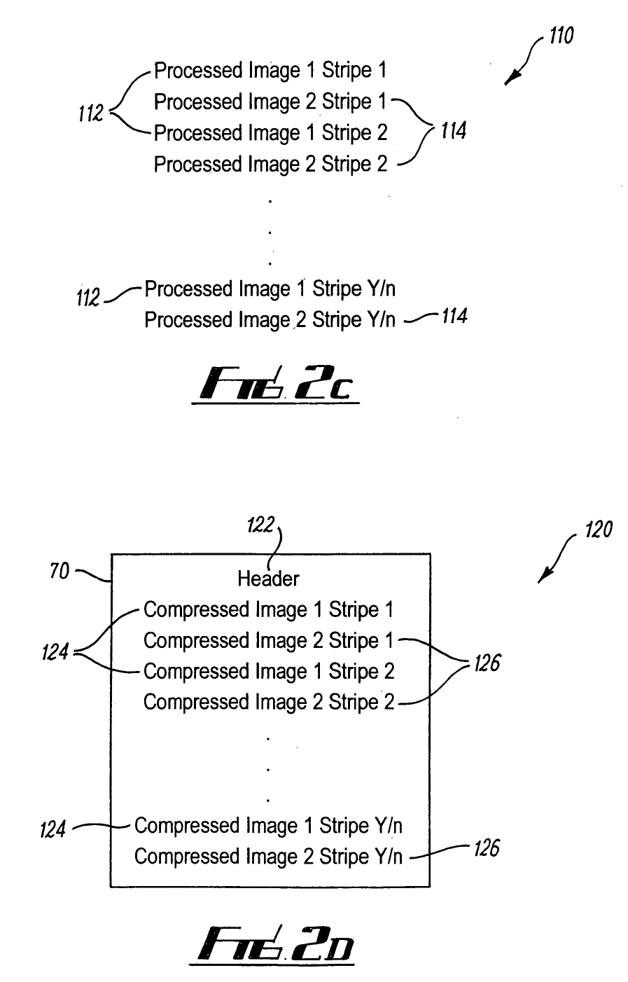

FIG. 3 illustrates the encoder 56 in more detail. A stripe selector 60 is followed by a stripe memory 61 and then by a standard encoder 62 such a JPEG or m-JPEG encoder. The stripe selector 60 receives the reconstructed image data 110 as illustrated in FIG. 2C as its is produced by the processor 40. This reconstructed data 110 includes a first sequence 112 of first data units (Processed Image 1 Stripe 1, Processed Image 1 Stripe 2, etc.) interleaved with a second sequence 114 of second data units (Processed Image 1 Stripe 1, Processed Image 1 Stripe 2, etc.), wherein each of the first data units 112 represents a processed stripe of first image data and each of the second data units 114 represents a processed stripe of second image data. The stripe selector 60 resets the standard encoder 62 at the beginning of each data unit. The standard encoder 62 compresses the data units in the order in which they are received at the stripe selector 60, on the fly, this negates the need for a frame memory and enable the use of a stripe memory that is capable of buffering one or two compressed stripes of image data. The output 120 of the encoder 56 is illustrated in FIG. 2D. The output 120 has the format of a file 70 of compressed data preceded by a header 122 identifying at least the size of a stripe n. This compressed data includes a first sequence 124 of compressed first data units (Compressed Image 1 Stripe 1, Compressed Image 1 Stripe 2, etc.) interleaved with a second sequence 126 of second data units (Compressed Image 1 Stripe 1, Compressed Image 1 Stripe 2, etc.), wherein each of the compressed first data units 124 represents a compressed stripe of first image data and each of the compressed second data units 126 represents a compressed stripe of second image data.

The file 70 may be stored in the memory 52, or transmitted via antenna 54.

It should be appreciated that at any one time compression occurs of either data from the first image or of data from the second image. Data from the first and second images are not simultaneously compressed.

The size of a stripe is determined by the standard encoder 56 used. If no compression is used, the stripe may be a single line of data i.e., n=1. If the standard encoder 56 is a JPEG or m-JPEG encoder then the stripe size n is a multiple of the minimum coding unit i.e. n=8*m, where m is an integer. The size of the stripe is preferably 8 or 16 lines i.e. n=8 or 16.

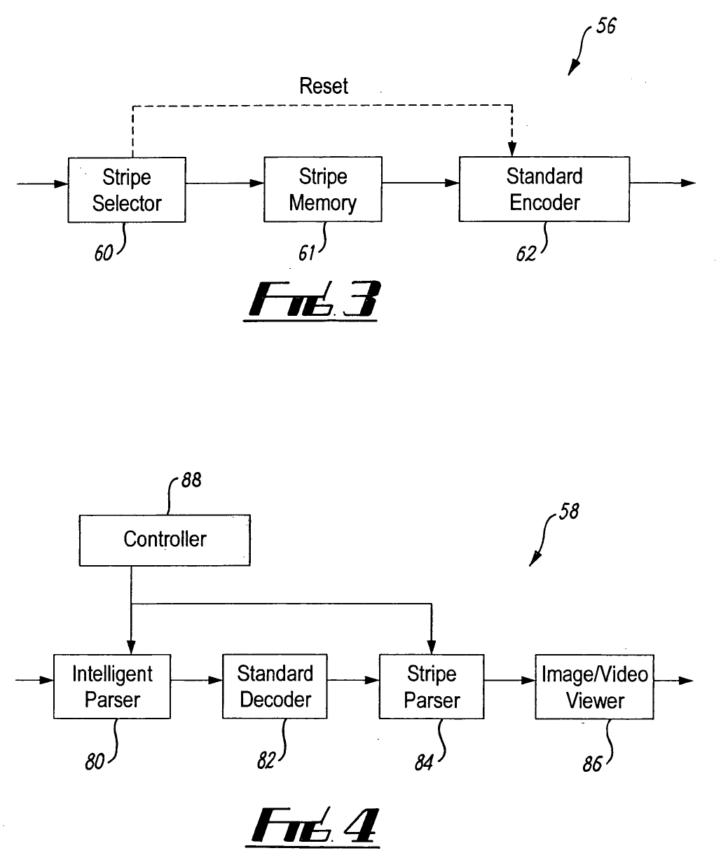

FIG. 4 schematically illustrates the decoder 58 of the host device 50 when operating as a decoder and playback device. The device 50 is capable of displaying on display 51 at least one image derived from the file 70.

The decoder 58 comprises a controller 88 and in series an intelligent parser 80, a standard decoder 82, a stripe parser 84 and an image/video viewer 86 for reproducing the first image and/or the second image on the display 51. The intelligent parser 80 reads the header of a received file 70 to determine whether or not the received file includes one or more images.

If the file contains only a single image, the intelligent parser passes the file directly to the standard decoder 82.

If the file contains dual images, the intelligent parser reads the stripe size n from the file header and provides it to the standard decoder 82. The intelligent parser then parses the compressed data in the file 70. This data comprises a first sequence 124 of first data units interleaved with a second sequence 126 of second data units, wherein each of the first data units 124 represents a compressed stripe of first image data and each of the second data units 126 represents a compressed stripe of second image data.

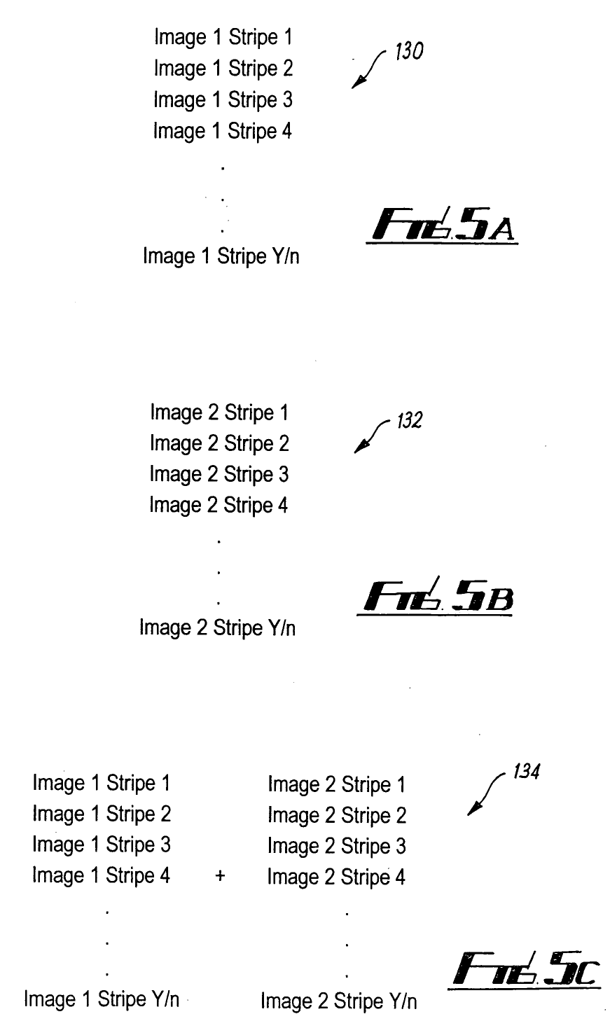

The intelligent parser 80 may isolate the first sequence 124 of first data units, each of which represents a compressed stripe of the first image and then decoder this first sequence 124 using the standard decoder to recover the first image on the image/video viewer 86. The input 130 to the image/video viewer provided by the standard decoder 58 is illustrated in FIG. 5A.

The intelligent parser 80 may isolate the second sequence 126 of second data units, each of which represents a compressed stripe of the second image and then decode this second sequence 126 using the standard decoder 58 to recover the second image on the image/video viewer 86. The input 132 to the image/video viewer provided by the standard decoder 58 is illustrated in FIG. 5B.

The intelligent parser 80 may isolate the first sequence 124 of first data units, each of which represents a compressed stripe of the first image and then decode this first sequence using the standard decoder. The intelligent parser 80 may additionally simultaneously isolate the second sequence 126 of second data units, each of which represents a compressed stripe of the second image and simultaneously decode this second sequence using the standard decoder. Thus the first and second images can be simultaneously recovered on the image/video viewer 86 to provide a stero-display. The input 134 to the image/video viewer provided by the standard decoder 58 is illustrated in FIG. 5C.

The intelligent parser 80 may be controlled by controller 88 to determine whether it isolates the first sequence 124 of first data units, the second sequence 126 of second data units or the first sequence 124 of first data units and the second sequence 126 of second data units. When its is controlled to isolate the first sequence of first data units and the second sequence of second data units, stripe parser 84 is enabled to parse the output of the standard decoder 82. When its is controlled to isolate the first sequence of first data units or the second sequence of second data units, the stripe parser 84 is disabled and it is transparent to the output of the standard decoder 82.

A user of the host device 50 may program the controller 88. Thus the user may select whether to display mono images or stereo images.

Although embodiments of the present invention have been described in the preceding paragraphs with reference to various examples, it should be appreciated that modifications to the examples given can be made without departing from the scope of the invention as claimed. For example, although in the preceding example, the dual camera system 10 uses a programmed processor 40, in other implementations hardware, such as an ASIC, may be used to perform this function. The processor (or ASIC) may be integrated into the first camera module or the second camera module for connection to a mobile telephone. Alternatively, it may be integrated into its own separate module for connection to a mobile telephone or integrated into a mobile telephone.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method of processing first image data representative of a first image and second image data representative of a substantially contemporaneous second image,
comprising:
processing stripes of the first image data sequentially;
processing stripes of the second image data sequentially;
outputting a first sequence of first data units interleaved with a second sequence of second data units, wherein
each of the first data units represents a processed stripe of first image data and each of the second data units represents a processed stripe of second image data.

2. A method as claimed in claim 1, comprising:
processing a first stripe of the first image data and a first stripe of a second image data; and
processing a second stripe of the first image data and a second stripe of a second image data;

3. A method as claimed in claim 2, wherein the first stripe of the first image and the first stripe of the second image are simultaneously processed and the second stripe of the first image and the second stripe of the second image are simultaneously processed.

4. A method as claimed in claim 1, comprising:
processing a first stripe of the first image data and a first stripe of a second image data;
and then outputting a primary data unit and a secondary data unit, wherein the primary data unit represents a processed first stripe of first image data and is the initial data unit in a sequence of first data units and the secondary data unit represents a processed second stripe of second image data and is the initial data unit in a sequence of second data units interleaved with the sequence of first data units.

5. A method as claimed in claim 1, wherein the output of the first sequence of first data units interleaved with a second sequence of second data units is as a single data entity.

6. A method as claimed in claim 5, wherein the data entity additionally indicates at least the size of a stripe.

7. A method as claimed in claim 1, wherein said processing occurs ‘on-the-fly’ without storing data representative of the whole of the first image or data representative of the whole of the second image.

8. A method as claimed in claim 1, wherein the processing steps comprise image reconstruction from data received from first and second image sensors or data formatting of image data received from first and second image processors.

9. A method as claimed in claim 1, wherein the output is provided to the base-band of a mobile telephone.

10. A method as claimed in claim 1, further comprising compressing a processed stripe of the first image data and then separately compressing a processed stripe of the second image data.

11. A method as claimed in claim 10, wherein the compression is provided by a standard encoder.

12. A device for processing first image data representative of a first image and second image data representative of a substantially contemporaneous second image,
the device comprising a first input for receiving first image data, a second input for receiving second image data and an output, wherein the device is arranged to process stripes of the first image data sequentially and process stripes of the second image data sequentially and output a first sequence of first data units interleaved with a second sequence of second data units, wherein each of the first data units represents a processed stripe of first image data and each of the second data units represents a processed stripe of second image data.

13. A device as claimed in claim 11, arranged to process a first stripe of the first image data and a first stripe of a second image data and subsequently process a second stripe of the first image data and a second stripe of a second image data.

14. A device as claimed in claim 13, arranged to simultaneously process the first stripe of the first image and the first stripe of the second image and arranged subsequently to process simultaneously the second stripe of the first image data and the second stripe of the second image data.

15. A device as claimed in claim 12, arranged to process a first stripe of the first image data and a first stripe of a second image data
and then output a primary data unit followed by a secondary data unit, wherein the primary data unit represents a processed first stripe of first image data and is an initial data unit in the sequence of first data units and the secondary data unit represents a processed first stripe of second image data and is the initial data unit in the sequence of second data units interleaved with the sequence of first data units and arranged to process a second stripe of the first image data and a second stripe of the second image data
and then output a primary data unit followed by a secondary data unit, wherein the primary data unit represents a processed second stripe of the first image data and is the second data unit in the sequence of first data units and the secondary data unit represents a processed second stripe of the second image data and is the second data unit in the sequence of second data units interleaved with the sequence of first data units.

16. A device as claimed in claim 12, arranged to output the first sequence of first data units interleaved with a second sequence of second data units as a single data entity.

17. A device as claimed in claim 16, wherein the data entity additionally indicates at least the size of a stripe.

18. A device as claimed in claim 12, further comprising a memory having a capacity sufficient to store at least two stripes of image data but insufficient to store the whole of the first image data.

19. A device as claimed in claim 12, wherein the processing comprises image reconstruction from data received from first and second image sensors.

20. A device as claimed in claim 12, wherein the processing comprises data formatting of first and second image data received from respective first and second image processing.

21. A device as claimed in claim 12, wherein the output is arranged for interfacing to the base-band of a mobile telephone.

22. A device as claimed in claim 12, further comprising a data compression means arranged to compress separately each data unit of the interleaved sequences of data units as they are output

23. A device as claimed in claim 22, wherein the data compression is a standard encoder.

24. A device as claimed in claim 12, further comprising two camera components each comprising at least a lens and a sensor.

25. A computer program which when loaded into a mobile telephone enables the mobile telephone to operate as the device as claimed in claim 12.

26. A data format for image data, comprising
a first sequence of first data units interleaved with a second sequence of second data units, wherein
each of the first data units represents a stripe of first image data and each of the second data units represents a stripe of second image data.

27. A method of displaying at least one image from a first sequence of first data units interleaved with a second sequence of second data units, comprising:
parsing input data comprising first data units and the second data units wherein each of the first data units represents a stripe of first image data and each of the second data units represents a stripe of second image data; and
using the parsed first data units and/or second data units to reproduce the first image and/or the second image.

28. A method as claimed in claim 27, including decompressing the parsed first data units and/or decompressing the second data units wherein each of the first data units represents a compressed stripe of first image data and each of the second data units represents a compressed stripe of second image data.

29. A method as claimed in claim 28, including parsing the first and second data units after decompression to reproduce the first and second images simultaneously.

30. A method as claimed in claim 27, including identifying whether parsing of the input data is required.

31. A method as claimed in claim 26, including determining whether the first data units should be used to reproduce the first image, the second data units should be used to reproduce the second image or the first and second data units should be used to simultaneously reproduce the first and second images.

32. A device for displaying at least one image derived from a first sequence of first data units interleaved with a second sequence of second data units, comprising:
parsing means for parsing input data comprising first data units and the second data units wherein each of the first data units represents a stripe of first image data and each of the second data units represents a stripe of second image data; and
reproduction means for reproducing the first image and/or the second image using the parsed first data units and/or parsed second data units.

33. A device as claimed in claim 32 wherein the reproduction means includes a decoder for decompressing the parsed first data units and/or decompressing the second data units wherein each of the first data units represents a compressed stripe of first image data and each of the second data units represents a compressed stripe of second image data.

34. A device as claimed in claim 33 wherein the decoder is a standard decoder.

35. A device as claimed in claim 33 wherein the reproduction means additionally parses the first and second data units after decompression to reproduce the first and second images simultaneously.

36. A device as claimed in claim 32 wherein the parsing means is arranged to identify whether parsing of the input data is required.

37. A device as claimed in claim 32 wherein the parsing means is arranged to determine whether the first data units should be used to reproduce the first image, the second data units should be used to reproduce the second image or the first and second data units should be used to simultaneously reproduce the first and second images.

38. A computer program which when loaded into a mobile telephone enables the mobile telephone to operate as the device as claimed in claim.
